(19) United States
(12) Patent Application Publication
(10) Pub. No.: US 2026/0267108 A1
(43) Pub. Date: Sep. 10, 2026

(54) DOME CLOSURE MOUNTING SYSTEM

(71) Applicant: CommScope Technologies LLC, Hickory, NC (US)

(72) Inventors: Johan GEENS, Bunsbeek (BE); Geert Jozef Maria VERBIST, Herentals (BE)

(73) Assignee: CommScope Technologies LLC, Hickory, NC (US)

(21) Appl. No.: 18/847,032

(22) PCT Filed: Mar. 14, 2023
(86) PCT No.: PCT/US2023/064329

§ 371 Date: Sep. 13, 2024

Related U.S. Application Data
(60) Provisional application No. 63/320,121, filed on Mar. 15, 2022.
(60) Provisional application No. 63/401,367, filed on Aug. 26, 2022.
(60) Provisional application No. 63/440,226, filed on Jan. 20, 2023.

(51) Int. Cl. G02B 6/46; G02B 6/44

(52) U.S. Cl. CPC G02B 6/46; G02B 6/4446

(57) ABSTRACT

The present disclosure relates to a mounting bracket for securing a dome closure at a mounting location in the field. The mounting bracket is adjustable to accommodate different sizes of dome closures. The mounting bracket is configured to allow a dome of the dome closure to be removed from a base of the dome closure while the base of the dome closure is supported by the mounting bracket.

### CROSS-REFERENCE TO RELATED APPLICATIONS

This application is being filed on Mar. 14, 2023, as a PCT International application and claims the benefit of and priority to U.S. Provisional Application No. 63/320,121, filed on Mar. 15, 2022, and claims the benefit of U.S. Provisional Application No. 63/401,367, filed on Aug. 26, 2022, and claims the benefit of U.S. Provisional Application No. 63/440,226, filed Jan. 20, 2023, the disclosures of which are hereby incorporated by reference in their entirety.

### BACKGROUND

Fiber optic communication systems allow service providers to deliver high bandwidth communication capabilities to customers. Fiber optic communication systems employ a distribution network of fiber optic cables to transmit large volumes of data over long distances. Fiber optic networks typically include optical terminals located in the field for providing optical connection locations. Optical terminals can be mounted on a variety of structures in the field including walls, poles, cables, and the like. In some instances, mounting brackets can be used to mount the optical terminals to a variety of structures in the field.

### SUMMARY

Aspects of the present disclosure relate to a mounting bracket for mounting a dome closure to a mounting location in the field. The mounting bracket includes a base piece including a holder for supporting a base of the dome closure. The mounting bracket also including an adjustable piece including an engagement feature for mating with a corresponding engagement feature of a dome of the dome closure. The adjustable piece is adjustable in position relative to the base piece to accommodate dome closures of different sizes. In one example, the adjustment piece is a slider that is linearly moveable along a linear guide defined by the base piece. In certain examples, the slider can be retained at a plurality of different retention locations along the linear guide with each retention location corresponding to a dome closure of a different size.

Aspects of the present disclosure also relate to a mounting bracket for attaching an optical terminal such as a dome closure to a structure such as a pole, wall, strand or other mounting location that may be encountered in the field. In certain examples, the mounting bracket can have a molded plastic construction. In certain examples, the mounting bracket can include a base piece defining a holder for receiving a base of the dome closure. The mounting bracket can also include a slider adapted to engage a dome of the dome closure. The base piece includes a slider mount section to which the slider mounts. The slider is linearly movable along a slide axis defined by the slider mount section to allow the slider to be moved linearly to different positions relative to the slide mount section. The slider can be retained at the different linear positions (e.g., by retainment features such as latches, snaps, fasteners, locks, or the like). The slider can be moved to the different linear positions relative to the base piece to accommodate dome closures of different sizes.

In certain examples, a metal stiffener (e.g., a metal channel) can be secured to the slide mount section to provide reinforcement of the dome closure mounting bracket at the slide mount section.

In certain examples, the dome closure can include a latching arrangement for latching the dome closure in place with respect to the mounting bracket when the dome closure is seated within the holder. In certain examples, the latching arrangement can be disengaged from the dome closure to allow the dome closure to be removed from the mounting bracket. In certain examples, the dome closure is moved in a linear motion along the central axis of the dome closure when the dome closure is installed on the mounting bracket and when the dome closure is disengaged from the mounting bracket.

In certain examples, the base piece of the mounting bracket includes at least two sets of fastener openings and the slider of the mounting bracket and includes at least one set of fastener openings.

Aspects of the present disclosure also relate to a mounting bracket for mounting a dome closure having a base and a dome. In certain examples, the base of the dome closure supports a cable sealing arrangement for sealing cables that are routed into the closure dome through the base. In certain examples, the base also includes an actuator for pressurizing the cable sealing arrangement. In certain examples, the base of the dome closure also supports a tower for supporting a plurality of management trays for managing optical fibers, for holding optical splices, and for holding optical components such as passive optical splitters, optical taps and wavelength division multiplexers. In certain examples, the tower is housed within the dome of the dome closure when the dome is mounted on the closure base. In certain examples, the dome can be installed on the closure base and removed from the closure base by moving the dome relative to the closure base along a central axis of the dome closure. In certain examples, the mounting bracket includes a holder for supporting the closure base when the dome closure is secured to the mounting bracket. In certain examples, the mounting bracket also includes an engagement feature that engages a mating feature of the dome when the dome closure is secured to the mounting bracket. In certain examples, a position of the engagement feature is adjustable relative to the holder to allow the mounting bracket to accommodate dome closures of different sizes. In certain examples, the dome closure can be secured to the mounting bracket and removed from the mounting bracket by moving the dome closure relative to the mounting bracket in a direction along the central axis of the dome closure. To engage the dome closure with the mounting bracket, the dome closure is moved in a first direction along the central axis of the dome closure relative to the mounting bracket to cause the closure base to seat in the holder of the mounting bracket and to concurrently cause the engagement feature of the mounting bracket to engage with the mating feature of the dome. To disengage the dome closure from the mounting bracket, the dome closure is moved in a second direction along the central axis of the dome closure relative to the mounting bracket to cause the closure base to disengage from the holder of the mounting bracket and to concurrently cause the engagement feature of the mounting bracket to disengage from the mating feature of the dome.

In certain examples, the dome of the dome closure can be removed from the closure base while the closure base remains seated at the holder of the mounting bracket. By removing the dome from the closure base while the closure base remains seated at the holder, a field technician can access the trays supported by the tower while the closure base remains supported by the mounting bracket. It will be appreciated that the dome can be removed from the closure base by moving the dome along the central axis of the dome closure relative to the closure base. As the dome is moved relative to the closure base along the central axis of the dome closure while the closure base is supported at the holder, the engagement feature of the mounting bracket disengages from the mating feature of the dome.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the examples disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is a front perspective view depicting a closure mounting bracket, in accordance with an embodiment of the disclosure.

FIG. 2 is a rear perspective view depicting the closure mounting bracket of FIG. 1.

FIG. 3 is an exploded view depicting the closure mounting bracket of FIG. 1.

FIG. 4 is a front view depicting the closure mounting bracket of FIG. 1.

FIG. 5 is a side view depicting the closure mounting bracket of FIG. 1, depicting an adjustment member at different mounting positions, in accordance with an embodiment of the disclosure.

FIG. 6 is a rear perspective view depicting a dome closure configured to be mounted to the closure mounting bracket of FIG. 1, in accordance with an embodiment of the disclosure.

FIG. 7 depicts the closure mounting bracket of FIG. 1 securing the dome closure of FIG. 6 to a pole, in accordance with an embodiment of the disclosure.

FIG. 8 depicts the closure mounting bracket of FIG. 1 securing the dome closure of FIG. 6 to a strand, in accordance with an embodiment of the disclosure.

FIG. 9 depicts the closure mounting bracket of FIG. 1 securing the dome closure of FIG. 6 to cable storage device, in accordance with an embodiment of the disclosure.

FIG. 10 is a side view depicting the dome closure of FIG. 6 secured to the closure mounting bracket of FIG. 1, in accordance with an embodiment of the disclosure.

FIG. 11 is a side view depicting the base of the dome closure of FIG. 6 seated on the closure mounting bracket of FIG. 1 and the dome of the dome closure in the process of being removed from the seated closure base, in accordance with an embodiment of the disclosure.

FIG. 12 is a side view depicting the base of the dome closure of FIG. 6 seated on the closure mounting bracket of FIG. 1 and the dome of the dome closure removed from the seated closure base, in accordance with an embodiment of the disclosure.

FIG. 13 is a side view depicting the base of the dome closure of FIG. 6 being lifted from the holder of closure mounting bracket of FIG. 1, in accordance with an embodiment of the disclosure.

FIG. 14 is a side view depicting an alternative dome closure secured to the closure mounting bracket of FIG. 1, in accordance with an embodiment of the disclosure.

FIG. 15 is a side view depicting still another dome closure secured to the closure mounting bracket of FIG. 1, in accordance with an embodiment of the disclosure.

FIG. 16 is a cross-sectional view cut vertically through the dome closure and closure mounting bracket of FIG. 10, in accordance with an embodiment of the disclosure.

FIG. 17A is a profile view depicting a closure bracket supporting a closure base relative to a workbench in a first configuration, in accordance with an embodiment of the disclosure.

FIG. 17B is a profile view depicting a closure bracket supporting a closure base relative to a workbench in a second configuration, in accordance with an embodiment of the disclosure.

FIG. 18A is a perspective view depicting a closure mounting bracket including an adjustable piece mounted in a first location, in accordance with an embodiment of the disclosure.

FIG. 18B is a profile view depicting a dome closure mounted on the closure mounting bracket of FIG. 18A, in accordance with an embodiment of the disclosure.

FIG. 19A is a perspective view depicting a closure mounting bracket including an adjustable piece mounted in a second location, in accordance with an embodiment of the disclosure.

FIG. 19B is a profile view depicting a dome closure mounted on the closure mounting bracket of FIG. 19A, in accordance with an embodiment of the disclosure.

FIG. 20A is a perspective view depicting a closure mounting bracket including an adjustable piece mounted in a third location, in accordance with an embodiment of the disclosure.

FIG. 20B is a profile view depicting a dome closure mounted on the closure mounting bracket of FIG. 20A, in accordance with an embodiment of the disclosure.

FIG. 21A is a front perspective view depicting a closure mounting bracket, in accordance with an embodiment of the disclosure.

FIG. 21B is a rear perspective view depicting a dome closure, in accordance with an embodiment of the disclosure.

FIG. 22 is a rear perspective view depicting the dome closure of FIG. 21B mounted to the closure mounting bracket of FIG. 21A, in accordance with an embodiment of the disclosure;

FIG. 23 is a partial, front perspective view depicting a portion of a closure mounting bracket including a slide bar operated resilient latch, in accordance with an embodiment of the disclosure.

FIG. 24 is a partial, rear perspective view depicting a dome closure, in accordance with an embodiment of the disclosure.

FIG. 25A is a top, plan view depicting a resilient latch and slide bar in a retaining position, in accordance with an embodiment of the disclosure.

FIG. 25B is a top, plan view depicting a resilient latch and slide bar in a non-retaining position, in accordance with an embodiment of the disclosure.

FIG. 26 is a perspective view depicting a coupling between a dome closure and a closure mounting bracket, in accordance with an embodiment of the disclosure.

FIG. 27 is a perspective view depicting an offset coupling between a large dome closure and closure mounting bracket, in accordance with an embodiment of the disclosure.

FIG. 28 is a perspective view depicting the operable coupling of an identifier to a closure mounting bracket, in accordance with an embodiment of the disclosure.

FIG. 29 is a perspective view depicting a portion of a resilient latch and slide bar, in accordance with an embodiment of the disclosure.

FIG. 30 is a cross-sectional view depicting the resilient latch on slide bar of FIG. 29, in accordance with an embodiment of the disclosure.

FIG. 31 is a perspective view depicting a portion of a resilient latch and slide bar, in accordance with an embodiment of the disclosure.

FIG. 32 is a cross-sectional view depicting the resilient latch on slide bar of FIG. 31, in accordance with an embodiment of the disclosure.

FIG. 33 is a perspective view depicting a portion of a cantilevered resilient latch, in accordance with an embodiment of the disclosure.

FIG. 34 is a cross-sectional view depicting the cantilevered resilient latch of FIG. 33, in accordance with an embodiment of the disclosure.

FIG. 35 is a perspective view depicting a portion of a cantilevered resilient latch, in accordance with an embodiment of the disclosure.

FIG. 36 is a cross-sectional view depicting the cantilevered resilient latch of FIG. 35, in accordance with an embodiment of the disclosure.

FIG. 37 is a perspective view depicting a portion of a cantilevered resilient latch, in accordance with an embodiment of the disclosure.

FIG. 38 is a cross-sectional view depicting the cantilevered resilient latch of FIG. 37, in accordance with an embodiment of the disclosure.

FIG. 39 is a cross-sectional view depicting an interaction between a cantilevered resilient latch, slide bar and dome closure, wherein the cantilevered resilient latches in the engaged position, in accordance with an embodiment of the disclosure.

FIG. 40 is a cross-sectional view depicting an interaction between a cantilevered resilient latch, slide bar and dome closure, wherein the cantilevered resilient latches in the unengaged position, in accordance with an embodiment of the disclosure.

FIG. 41 is a cross-sectional view depicting an interaction between a cantilevered resilient latch, slide bar and dome closure, wherein an external has been exerted on the dome closure, causing the dome closure to shift relative to the resilient latch, in accordance with an embodiment of the disclosure.

FIG. 42 is a cross-sectional view depicting an interaction between a cantilevered resilient latch, slide bar and dome closure, wherein an external has been exerted on the dome closure, causing the resilient latch to grab both a portion of the dome closure and slide bar, in accordance with an embodiment of the disclosure.

### DETAILED DESCRIPTION

Reference will now be made in detail to exemplary aspects of the present disclosure that are illustrated in the accompanying drawings. Wherever possible, the same reference numbers will be used throughout the drawings to refer to the same or like parts.

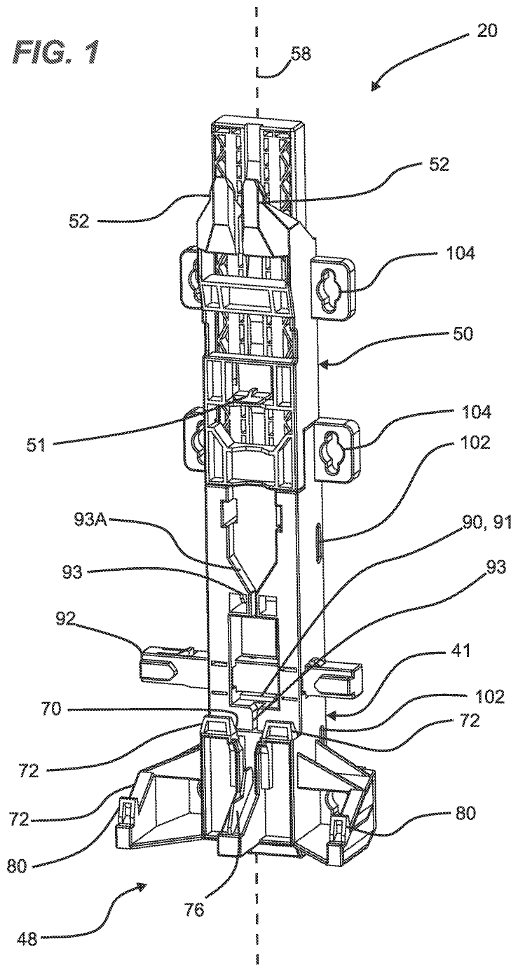

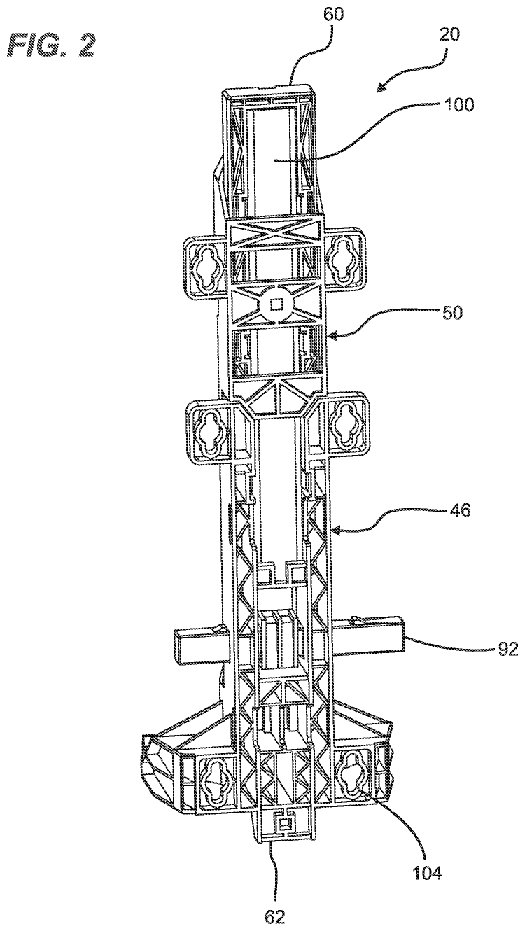

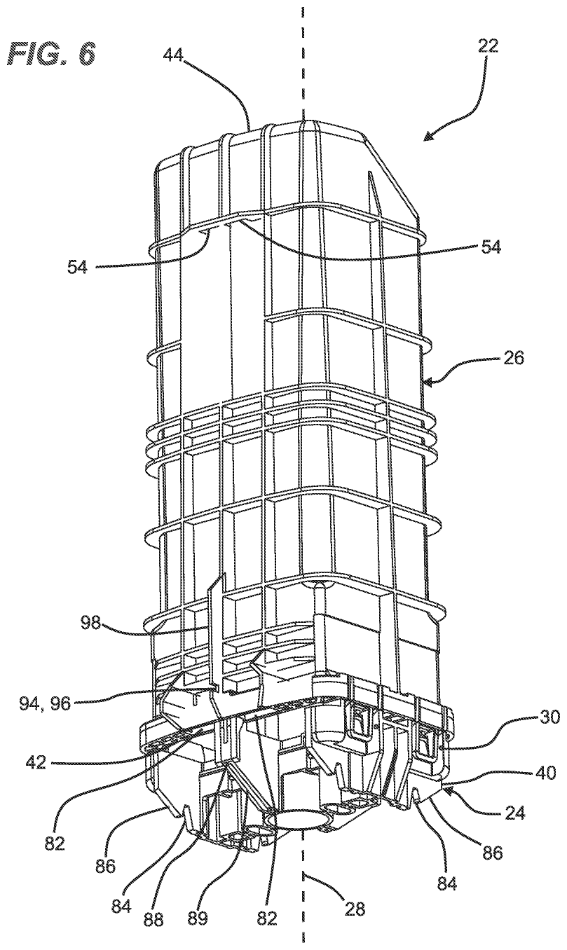

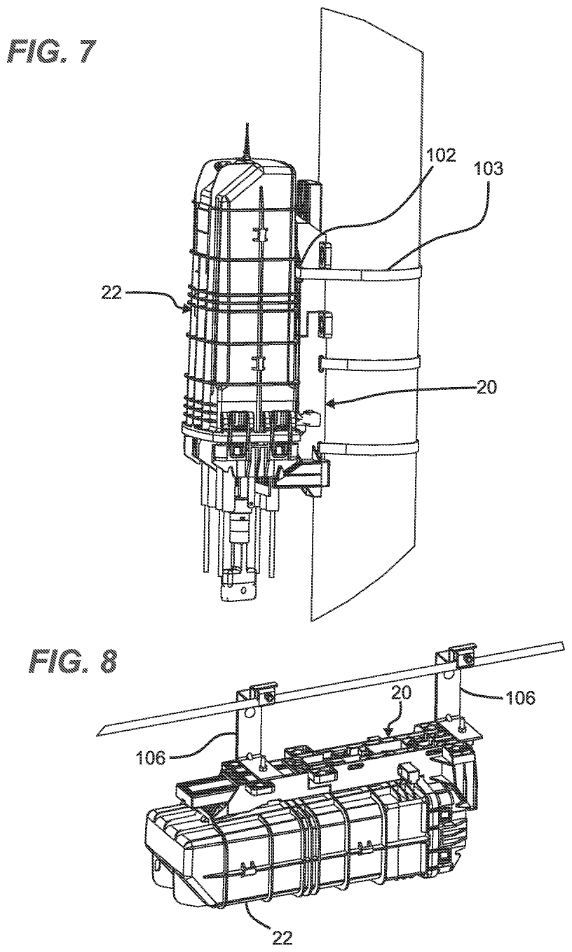

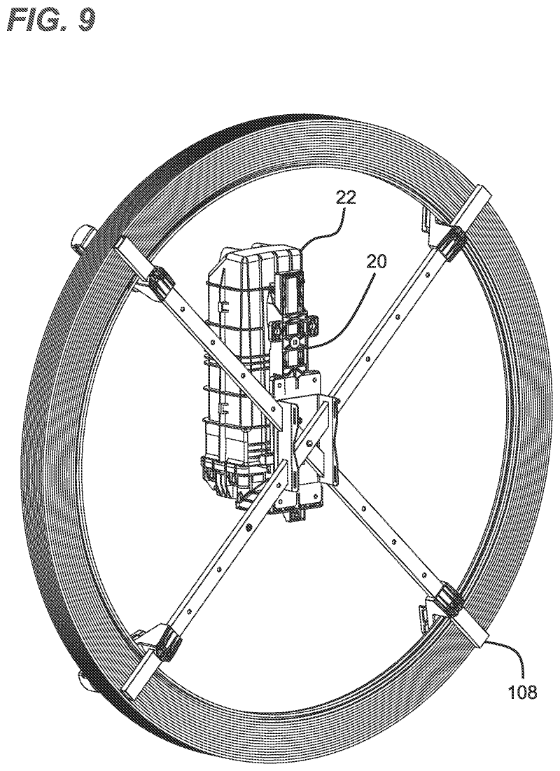

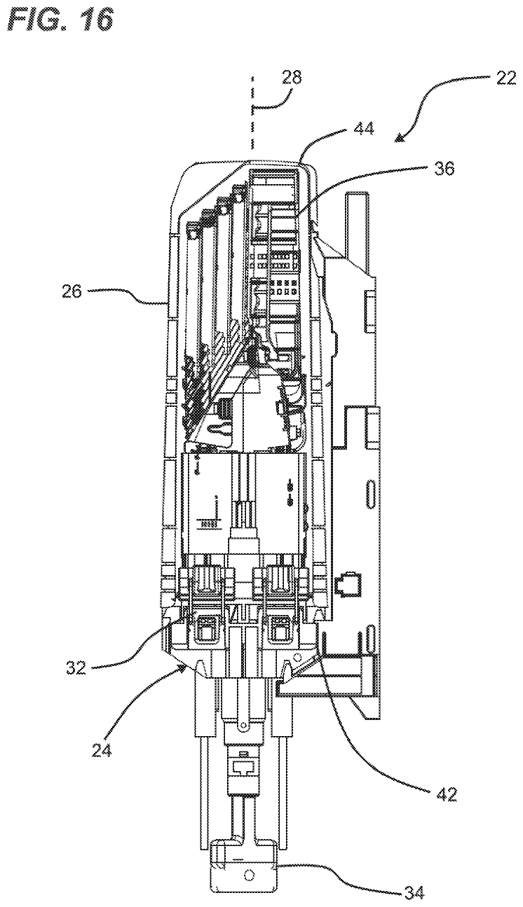

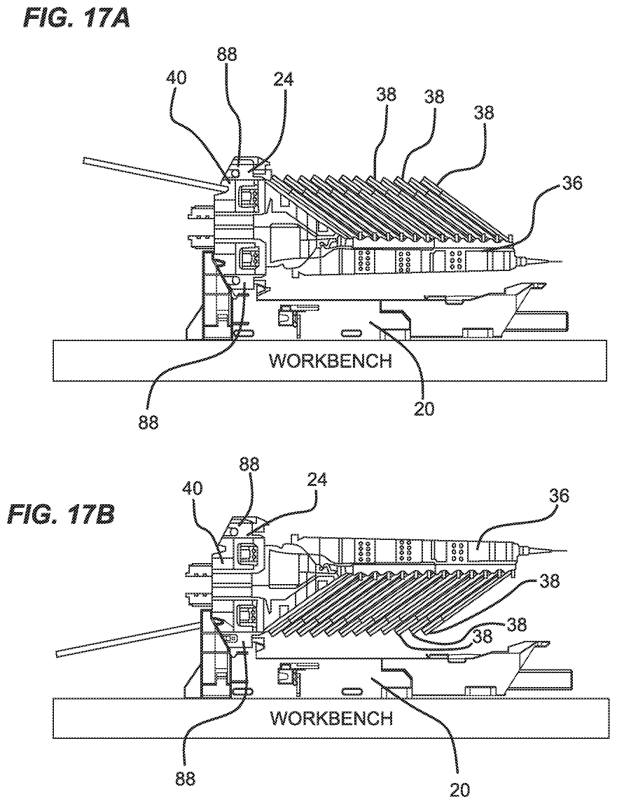

FIGS. 1-5 depict a closure mounting bracket 20 in accordance with the principles of the present disclosure. In one example, the closure mounting bracket 20 is configured for mounting a closure such as a dome closure (e.g., see dome closure 22 at FIG. 6) to a mounting location in the field. Example structures in the field to which the dome closure 22 can be mounted using the closure bracket 20 include walls, towers or poles (as depicted in FIG. 7), strands (as depicted in FIG. 8), cable spooling device (as depicted in FIG. 9), work benches (as depicted in FIG. 17A-B), and other structures encountered in the field while deploying a fiber-optic network.

As depicted at FIG. 6, the dome closure 22 includes a closure base 24 and a dome 26 that mounts on the closure base 24. The dome closure 22 has a length that extends along a central longitudinal axis 28 of the dome closure 22. In one example, latches 30 are used to secure the dome 26 to the closure base 24. In other examples, fasteners, straps, clamps or other structures may be used to secure the dome 26 to the closure base 24.

When the closure base 24 and the dome 26 are secured together, an interior of the dome 26 is preferably sealed with respect to the outside environment. For example, the closure base 24 can carry a sealing arrangement 32 (see FIG. 16) adapted to provide a perimeter seal within an interior of the dome and also adapted to seal about cables routed into the interior of the dome 26 through the closure base 24. The closure base 24 can also carry an actuator 34 (see FIG. 16) for pressurizing the sealing arrangement 32.

The closure base 24 can support a tower 36 that is positioned within the sealed interior of the dome 26 when the closure base 24 and the dome 26 are secured together. The tower 36 can support a plurality of trays 38 for managing optical structures such as optical fibers, optical splices, passive optical splitters, optical taps, wavelength division multiplexers and other optical structures. The dome 26 is installed on the closure base 24 by inserting the dome 26 over the closure base 24 in a direction along the central longitudinal axis 28. Once the dome 26 has been inserted over the base 24, the dome 26 can be latched to the closure base 24, for example by latches 30. The dome 26 can be removed from the closure base 24 by unlatching the latches 30, and then lifting the dome 26 from the closure base 24 in a direction along the central longitudinal axis 28. The closure base 24 can include a frame 40 that supports the tower 36, the sealing arrangement 32 and the actuator 34. The dome 26 has an open end 42 for receiving the closure base 24 and a closed end 44 positioned opposite the open end 42.

Referring again to FIGS. 1-5, the closure mounting bracket 20 includes a base piece 46 defining a holder 48 for supporting the closure base 24. The holder 48 is adapted for mechanically interfacing with (e.g., mating with) a lower end portion of the closure base 24. The holder 48 can also be referred to as a retainer, a support or a cradle.

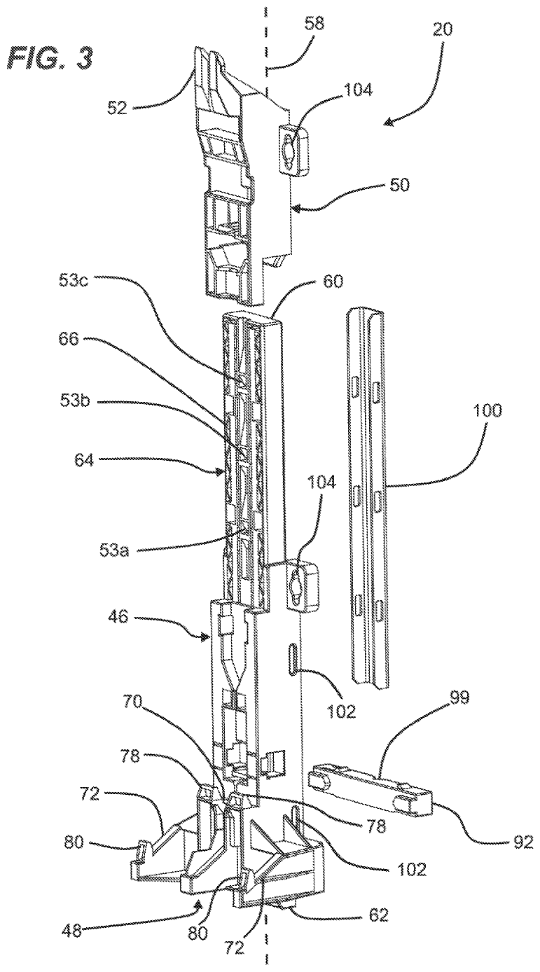

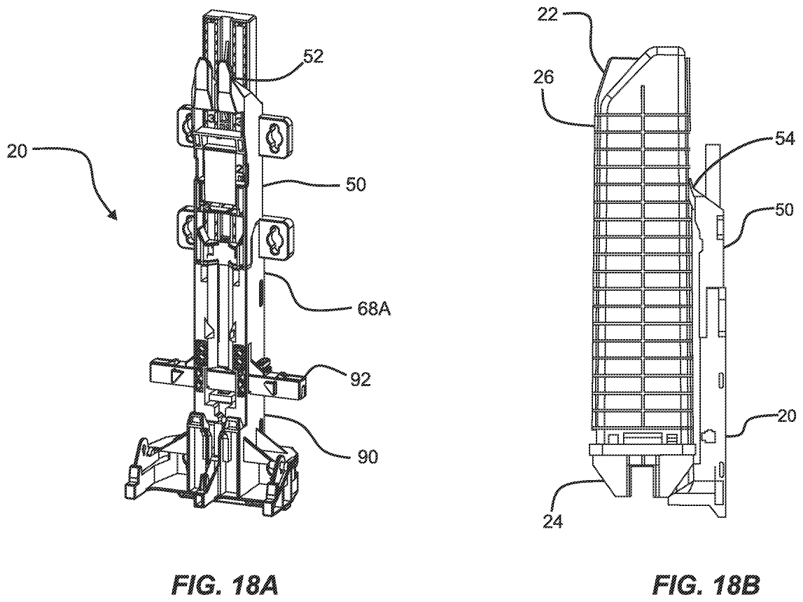

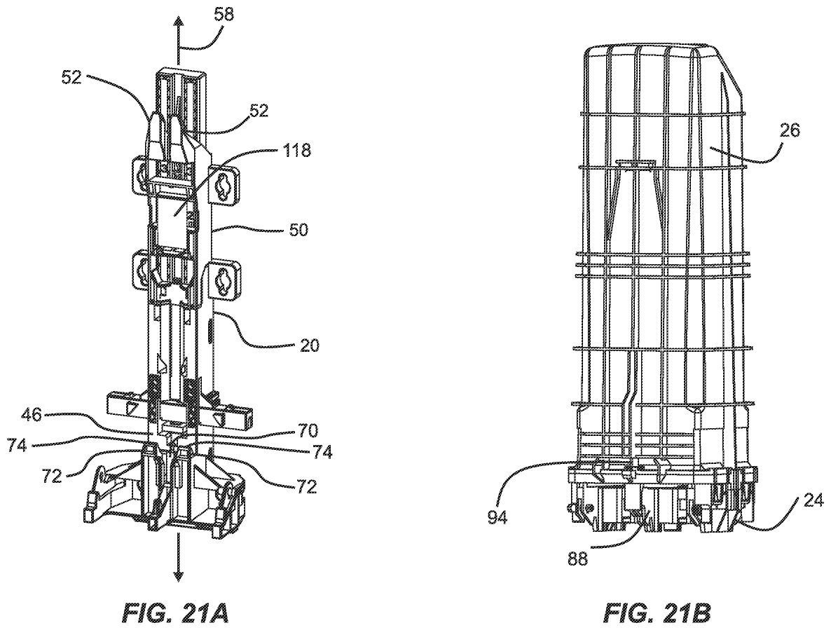

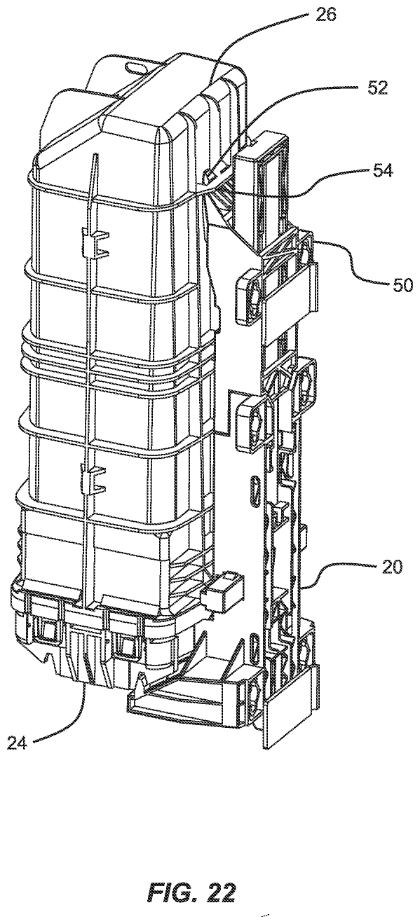

The closure mounting bracket 20 also includes an adjustable piece 50 (e.g., see FIG. 3) including an engagement feature 52 for mating with a corresponding engagement feature 54 of the dome 26 (e.g., see FIG. 6). The adjustable piece 50 is adjustable in position relative to the base piece 46 to accommodate dome closures of different sizes (e.g., see FIGS. 18A-20B). In the depicted examples, the dome engagement feature 52 is shown including a pair of hooks and the mating engagement feature 54 is shown including a pair of openings for receiving the hooks (e.g., see FIGS. 21A-B and 22). In alternative examples, the engagement feature 52 on the adjustable piece 50 can be a female feature such as an opening and the mating engagement feature 54 on the dome 26 can be a male feature such as a hook. In certain examples, the base piece 46 and the adjustable piece 50 can be of a molded plastic construction.

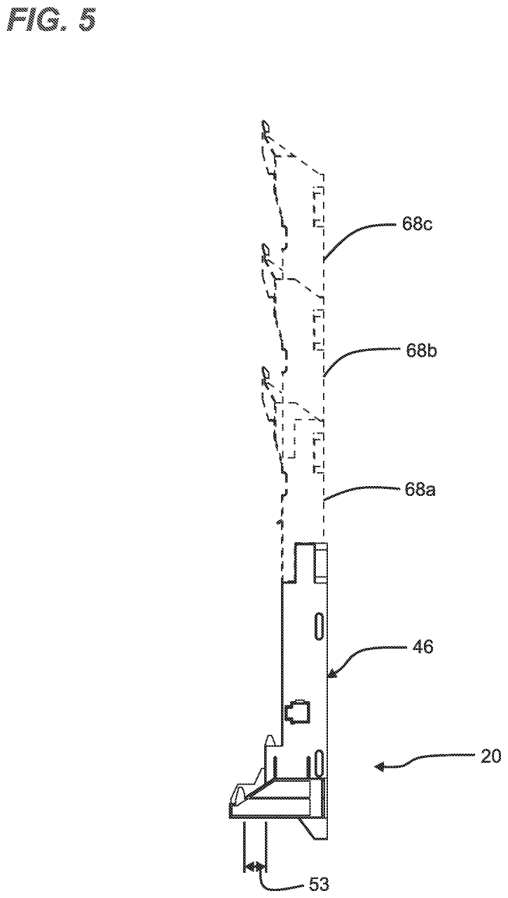

The base piece 46 includes a length L that extends along a longitudinal axis 58 of the base piece 46 between a first end 60 (e.g., an upper end) and a second end 62 (e.g., a lower end). The holder 48 for supporting the closure base 24 is located at the second end 62. In the depicted example, the adjustment piece 50 is shown as a slider. The base piece 46 includes a slider mounting section 64 adjacent to the first end 60. The slider mount section 64 includes a linear guide 66 on which the adjustment piece 50 mounts. The adjustment piece 50 is linearly movable along the linear guide 66 in an orientation parallel to the longitudinal axis 58 to enable the adjustment piece 50 to be adjusted in position relative to the base piece 46. In certain examples, the adjustment piece 50 can be selectively retained at a plurality of locations spaced-apart along the slider mounting section 64 with each location corresponding to a different sized dome closure (see e.g., FIG. 5). In certain examples, the adjustment piece 50 can include a retention element (e.g., a fastener, a latch, receptacle, a catch, or other structure) adapted to engage with corresponding retention elements provided along the slider mounting section 64 for allowing the adjustment piece 50 to be retained at a given one of the different locations. As depicted, the adjustment piece 50 includes a resilient latch 51 adapted to selectively engage three different catches 53A-53C spaced axially along the slider mounting section 64 (see e.g., FIG. 3). In embodiments, the resilient latch 51, which in some embodiments can be in the form of a cantilevered member, can be manipulated to enable a free sliding between the adjustment piece 50 and the base piece 46. In some embodiments, the resilient latch 51 can be biased by material properties of the resilient latch 51 to naturally engage with the base piece 46.

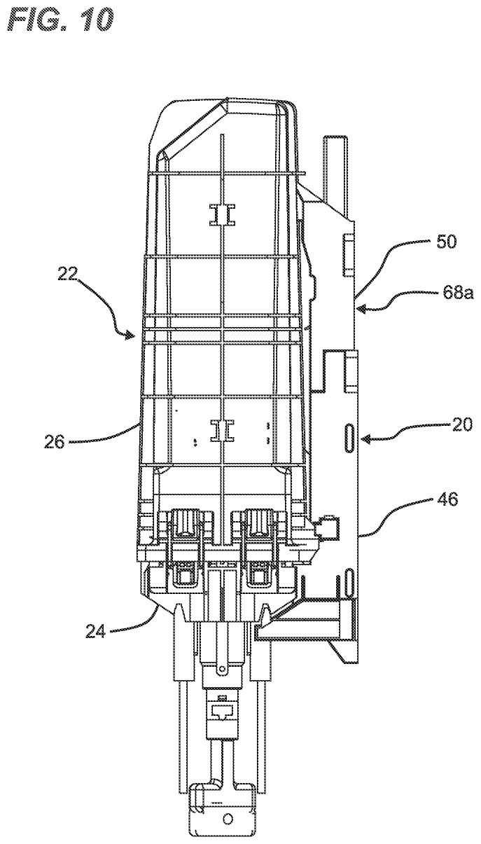

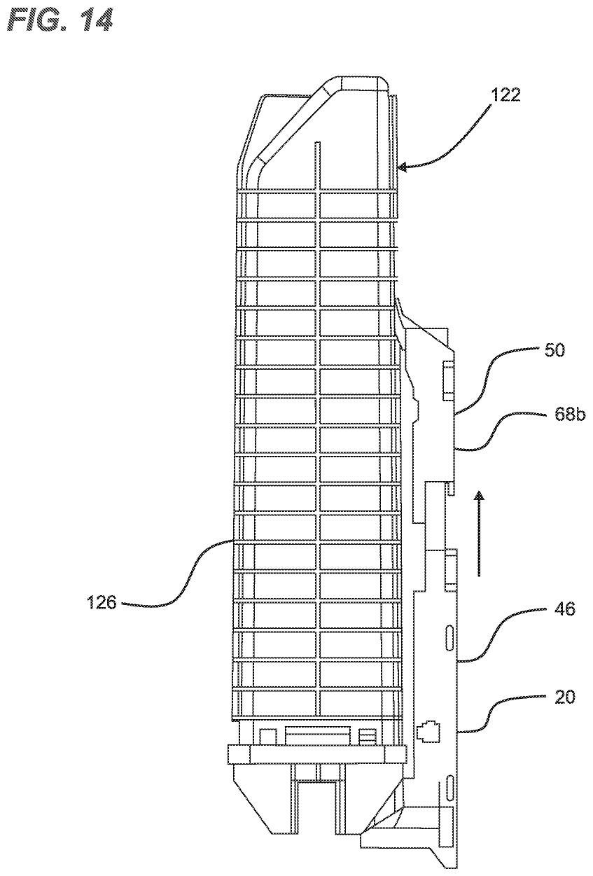

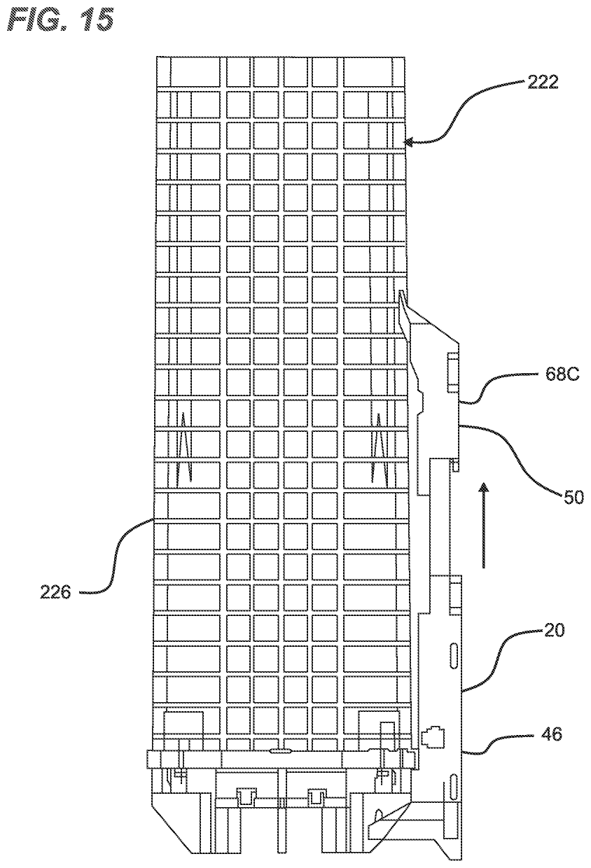

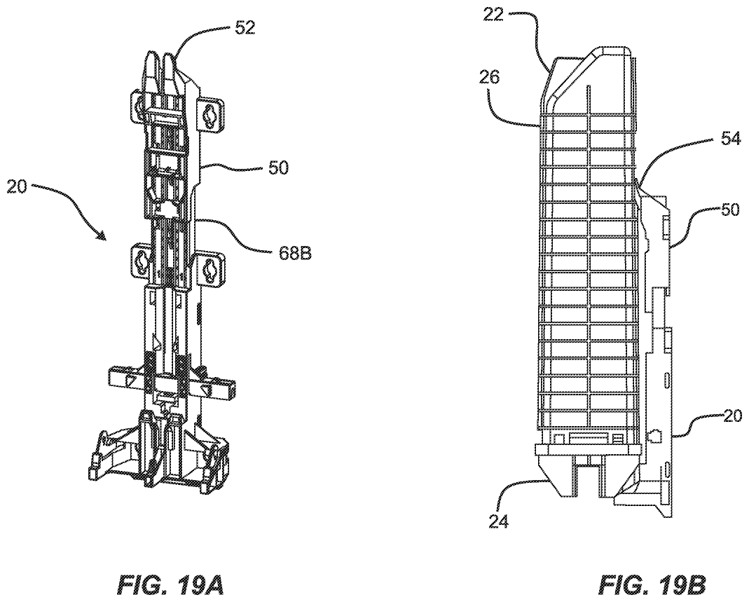

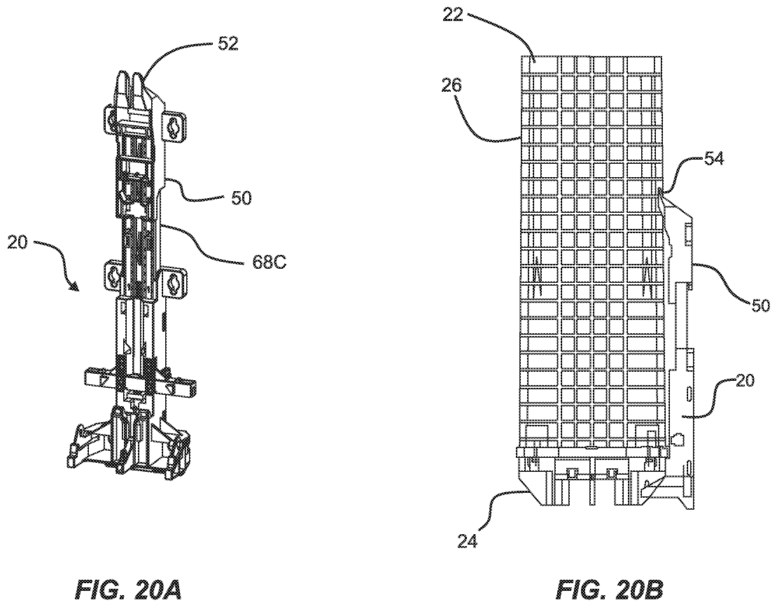

FIGS. 5, 18A, 19A, and 20A depict the adjustment piece 50 positioned at multiple locations along the slider mounting section 64 including a first location 68A (e.g., a lower location), a second location 68B (e.g., an intermediate location) and a third location 68C (e.g., an upper location). Referring to FIGS. 10 and 18A-B, the first location 68A corresponds to the location of the engagement feature 54 on the dome 26 of the dome closure 22. Referring to FIGS. 14 and 19A-B, the second location 68B corresponds to the location of an engagement feature on a dome 126 of a dome closure 122 that is larger than the dome closure 22. Referring to FIGS. 15 and 20A-B, the third location 68C corresponds to the location of an engagement feature on a dome 226 of a dome closure 222 that is larger than the dome closure 122.

The holder 48 of the mounting bracket 20 is depicted as including a plurality of female features for receiving male features of the closure base 24 and also including a plurality of male features adapted to be received within the male features of the closure base 24. In embodiments, female features of the holder 48 can include a central channel 70 aligned with the longitudinal axis 58 of the base piece 46 and notches 72 positioned on opposite sides of the longitudinal axis 58. (see e.g., FIGS. 1, 3 and 21). The notches 72 are defined by cradle arms 74 positioned on opposite sides of the longitudinal axis 58. The central channel 70 extends vertically along the longitudinal axis 58 and includes an open top end.

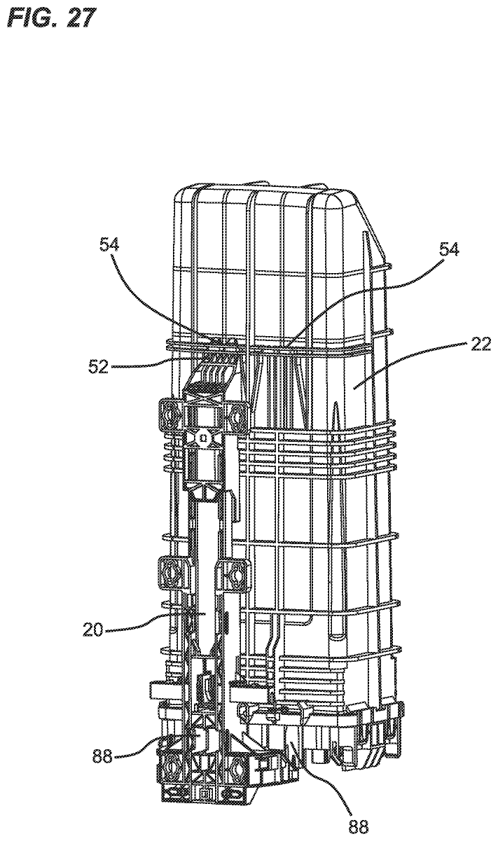

In some embodiments, the central channel 70 can include a generally T-shaped cross-sectional void, configured to receive a retaining member(s) 88 of a corresponding shape adapted to slide vertically into the central channel 70. In one embodiment, the closure base 24 can include one or more retaining members 88. For example, as depicted in FIGS. 17A-B, in some embodiments, the closure base 24 can include a pair of retaining members 88, with retaining members 88 positioned on opposing sides of the closure base 24 to enable the closure base 24 to be oriented in at least two different positions relative to the mounting bracket 20. In another embodiment, two or more retaining members 88 can be positioned on a single side of the closure base 24, enabling a longitudinal axis of the closure base 24 to be offset relative to the longitudinal axis of the mounting bracket 20 (as depicted in FIG. 27).

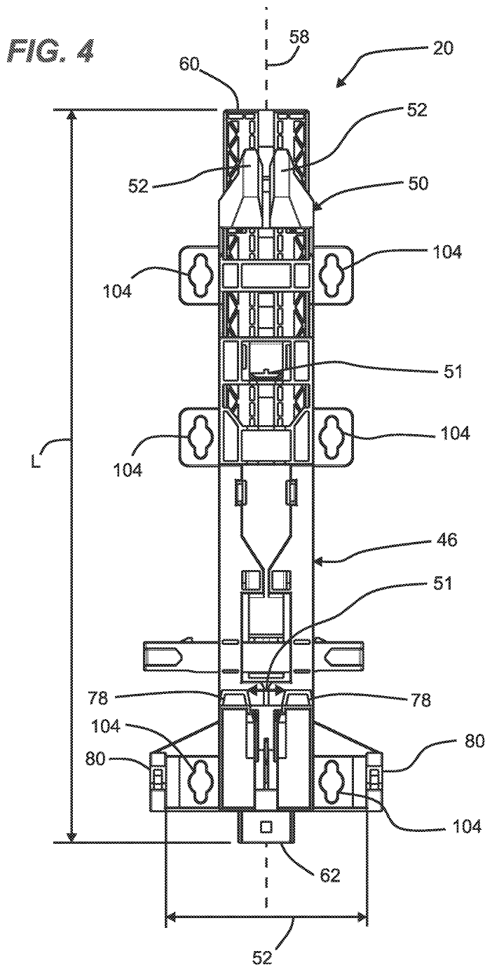

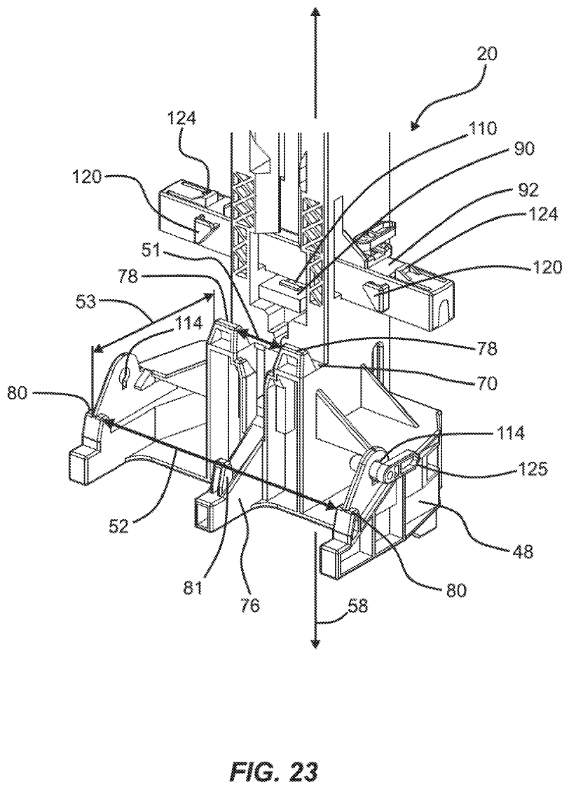

In embodiments, the male features of the holder 48 can include a central alignment fin 76 aligned with the longitudinal axis 58 and positioned in front of the central channel 70. As depicted in FIGS. 4 and 23, male features of the holder 48 can also include first hooks 78 positioned on opposite sides of the longitudinal axis 58 and separated by a lateral spacing S1. The male features of the holder 48 can further include second hooks or protuberances 80 position on opposite sides of the longitudinal axis 58 and separated by a lateral spacing S2 larger than the lateral spacing S1. The first hooks 78 can be spaced from the second hooks 80 by an axial spacing S3 measured along the longitudinal axis 58 as shown at FIGS. 5 and 23. In some embodiments, an optional additional hook or protuberance 81 can be positioned between second hooks 80, for example, along alignment fin 76 of the holder 48. The first hooks 78 can be located adjacent a top of the holder 48 adjacent to the top end of the central channel 70 and the second hooks 80 and optional additional hook or protuberance 81 can be located adjacent to the bottom of the holder 48.

The bottom of the closure base 24 is configured to mate with the male and female features defined by the holder 48 of the base piece 46. For example, the closure base 24 can include openings 82 for receiving the first hooks 78, notches 84, 85 for receiving the protuberances 80, 81 and projections 86 for being received within the notches 72 defined by the cradle arms 74 of the holder 48. The closure base 24 can also include retaining members 88 adapted to slide vertically into the central channel 70. In one example, the retaining members 88 can have a T-shaped cross sectional profile. In some embodiment, the retaining members 88 further include a slit 89 for receiving the alignment fin 76 of the holder 48.

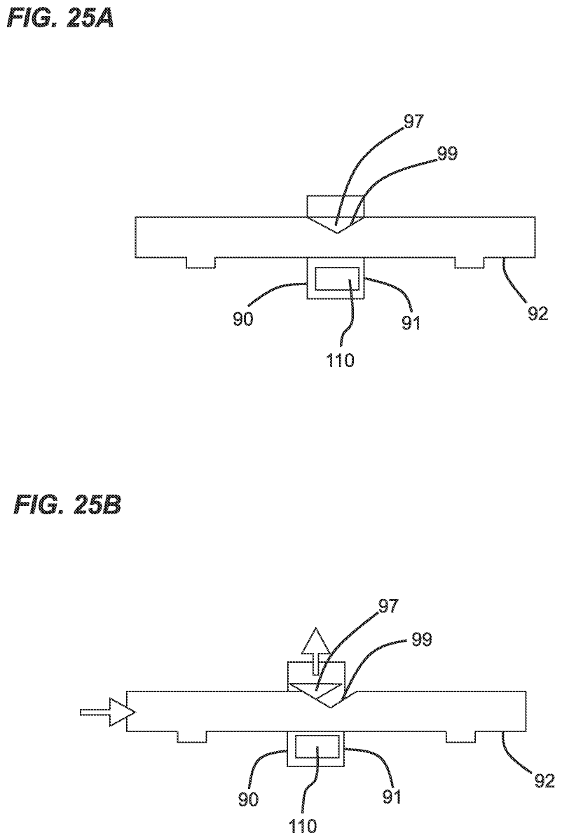

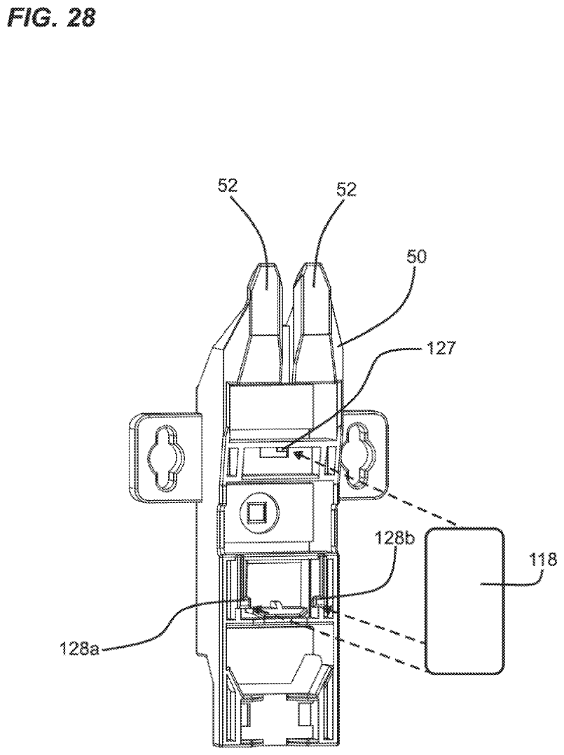

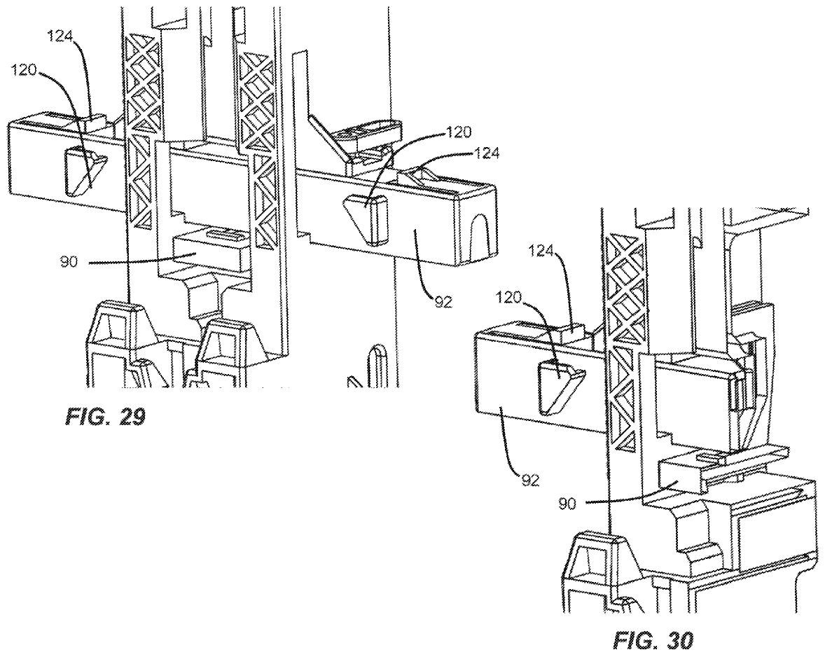

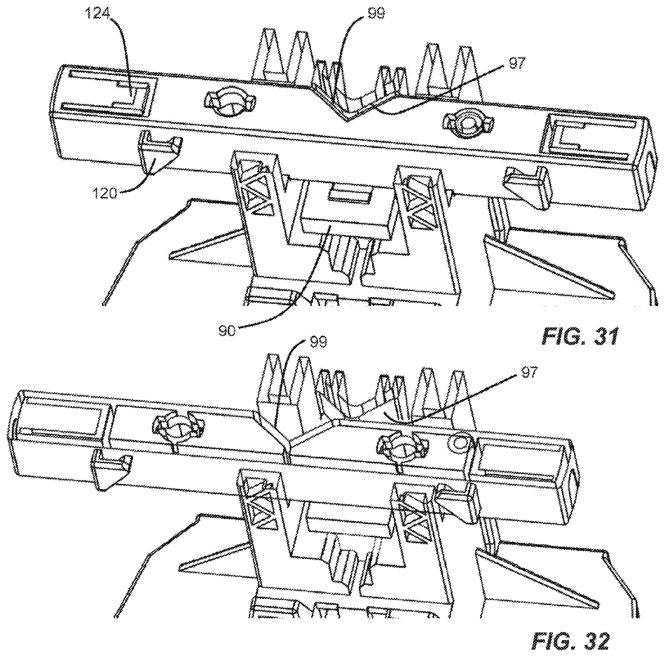

The mounting bracket 20 further includes a resilient latch 90 for latching the dome closure 22 in place relative to the mounting bracket 20 when the closure base 24 seats in the holder 48. With reference to FIGS. 25A-B and 29-32, the resilient latch 90 is biased toward a retaining position and is movable from the retaining position to a non-retaining position via an actuator such as a slide bar 92. When the dome closure 22 is installed on the mounting bracket 20, the resilient latch 90 fits within or otherwise engages with a portion the dome 26 to inhibit the dome closure 22 from axially separating from the holder 48. By moving the resilient latch 90 from the retaining position (as depicted in FIGS. 25A, 29, 30 and 31) to the non-retaining position (as depicted in FIGS. 25B and 32), the dome closure 22 can be disengaged from the mounting bracket 20 by lifting the dome closure 22 in a direction along the longitudinal axis 58 of the base piece 46.

In the depicted example, the resilient latch 90 includes a catch 91 that projects forwardly when the resilient latch 90 is in the retaining position (as depicted in FIG. 25A) and that is recessed rearwardly from the retaining position when the resilient latch is in the non-retaining position (as depicted in FIG. 25B). In the depicted example, the catch 94 of the dome 26 is formed by a notch 96 defined within an alignment rail 98 that extends parallel to the central axis 28 of the dome closure 22. When the dome closure 22 is installed on the mounting bracket 20, the resilient latch 90 fits within a vertical guiding slot 93 defined within the base piece 46 above the holder 48. In certain examples, at least one vertical guiding slot 93 can have a tapered lead-in section 93A for guiding the resilient latch 90 into the vertical guiding slot 93. The vertical guiding slot 93 can align with the central channel 70 and the alignment fin 76, and the resilient latch 90 can align with the retaining members 88 and the slit 89. In other embodiments, the resilient latch 90 can define an aperture 110, which can be configured to receive one or more projections 112 defined on an inner surface of the notch 96 defined by the dome closure 22, such that when a lifting force is applied to the dome closure 22 when with the resilient latch 90 in the retaining position, the one or more projections 112 enter the aperture 110 as an aid in retaining a secure connection between the dome closure 22 and the mounting bracket 20.

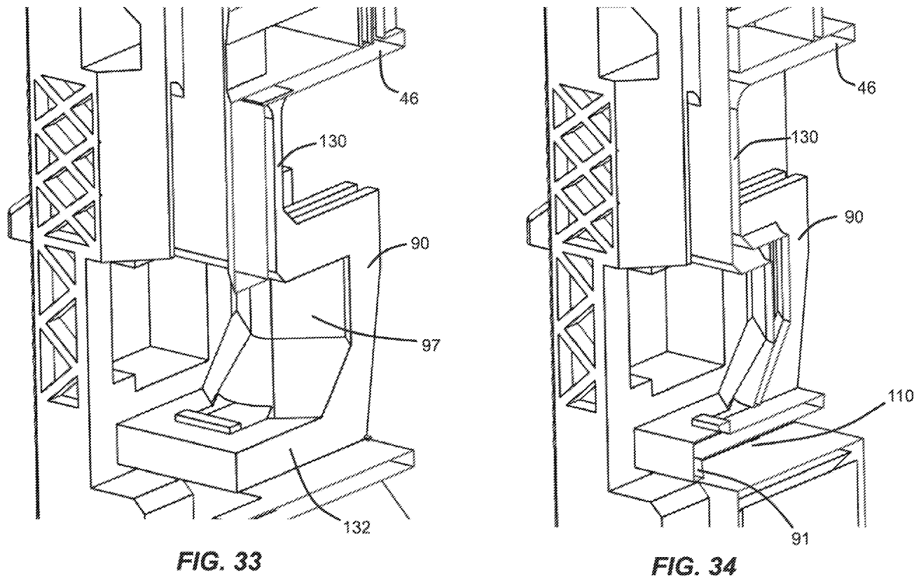

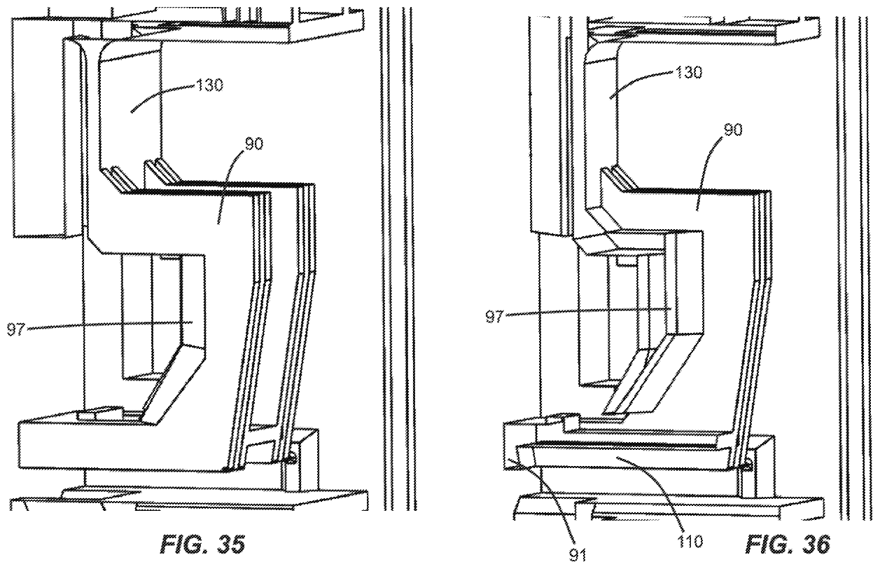

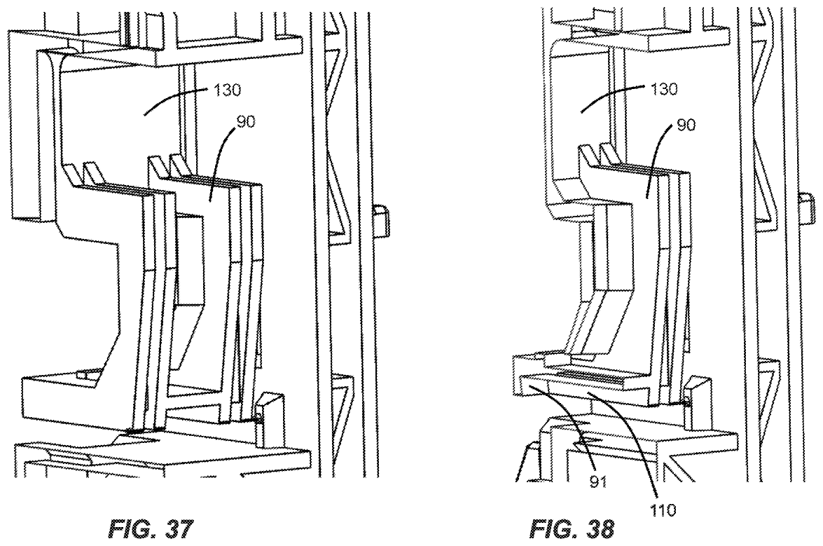

With continued reference to FIGS. 25A-B and 29-32, the slide bar 92 can be mounted for lateral sliding motion relative to the base piece 46. For example, with additional reference to FIGS. 33-38, the resilient latch 90 can be in the form of a cantilevered member generally oriented parallel to the longitudinal axis of the mounting bracket 20. In embodiments, cantilevered resilient latch 90 can have resilient material qualities enabling the resilient latch 90 to flex relative to the base piece 46 between an unbiased retaining position, in which the cantilevered resilient latch 90 is in a relaxed or unflexed position (as depicted in FIG. 31), and a biased non-retaining position, in which the cantilevered resilient latch 90 is flexed away from the dome closure 22 by the slide bar 92 (as depicted in FIG. 32.

In some embodiments, the slide bar 92 can include an angled groove or notch 99 having surfaces that are adapted to engage a generally wedge shaped projection 97 of the resilient latch 90 to move the resilient latch 90 rearwardly from the retaining position to the non-retaining position when the slide bar is moved laterally to the left or to the right of a centered position. In the retaining position (as depicted in FIGS. 25A and 31), the wedge shaped projection 97 can nest within the notch 99. Conversely, in the non-retaining position (as depicted in FIGS. 25B and 32), the wedge shaped projection 97 can slide out of the notch 99, which can have the effect of shifting the cantilevered resilient latch 90 to a biased, non-retaining position, in which the cantilevered resilient latch 90 is flexed away from the dome closure 22. Other examples of slide bars for actuating retaining arms are disclosed by PCT international publication number WO2021/092177 which is hereby incorporated by reference in its entirety.

In some embodiments, the slide bar 92 can include one or more protuberances 120 configured to interact with one or more projections 123 of the dome 26 to aid in retention of the slide bar 92 in a generally centered position. To further aid in retention of the slide bar 92 relative to the base piece 46, in some embodiments, the slide bar 92 can include one or more tabs 124 configured to inhibit inadvertent sliding of the slide bar 92 entirely through the base piece 46. Conversely, actively pressing on the one or more tabs 124 while sliding the slide bar 92 can enable selective removal of the slide bar 92 from the base piece 46.

With additional reference to FIGS. 33-38, the resilient cantilevered latch 90 can be monolithically formed as a component of the base piece 46, such that the resilient cantilevered latch 90 is able to resiliently flex relative to the base piece 46 between an unflexed position (as depicted in FIG. 31), and a flexed position (as depicted in FIG. 32). For example, in some embodiments, the resilient cantilevered latch 90 can include a cantilever arm 130 extending generally along the longitudinal axis 58 of the base piece 46. The cantilever arm 130 can be operably coupled to the wedge shaped projection 97, which can be configured to interact with a corresponding notch 99 defined by the slide bar 92 to transition the resilient cantilevered latch 90 between the flexed and on flexed positions. The latch portion 132 of the resilient cantilevered latch 90 can be operably coupled to the wedge shaped projection 97, and in some embodiments can be positioned generally orthogonal to the cantilever arm 130.

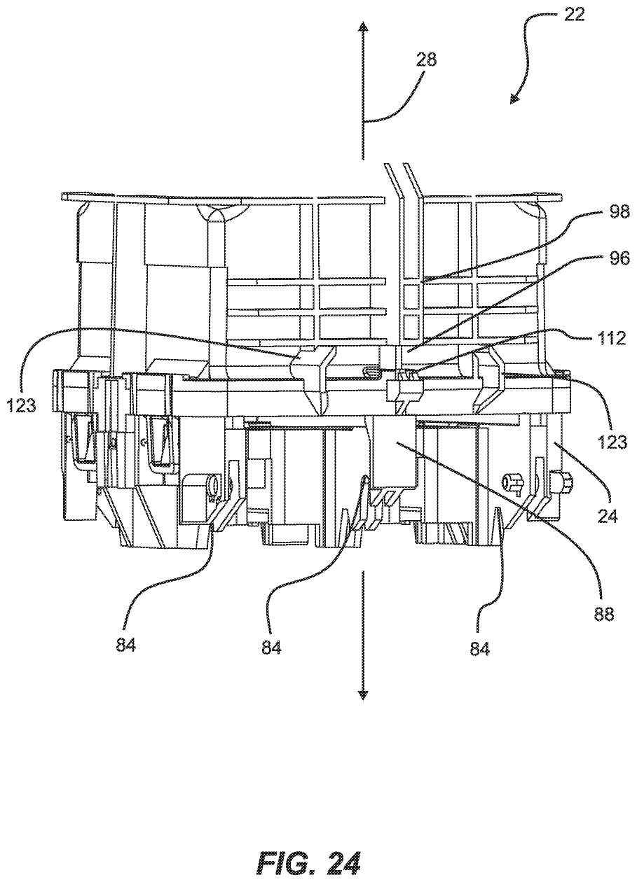

As depicted, in embodiments, the latch portion 132 can include a catch 91, which can serve to define a receptacle generally configured to receive one or more projections 112 (as depicted in FIG. 24) defined on an inner surface of the notch 96 defined by the dome closure 22, such that when a lifting force is applied to the dome closure 22 when with the resilient latch 90 in the retaining position, the one or more projections 112 enter the receptacle as an aid in retaining a secure connection between the dome closure 22 and the mounting bracket 20.

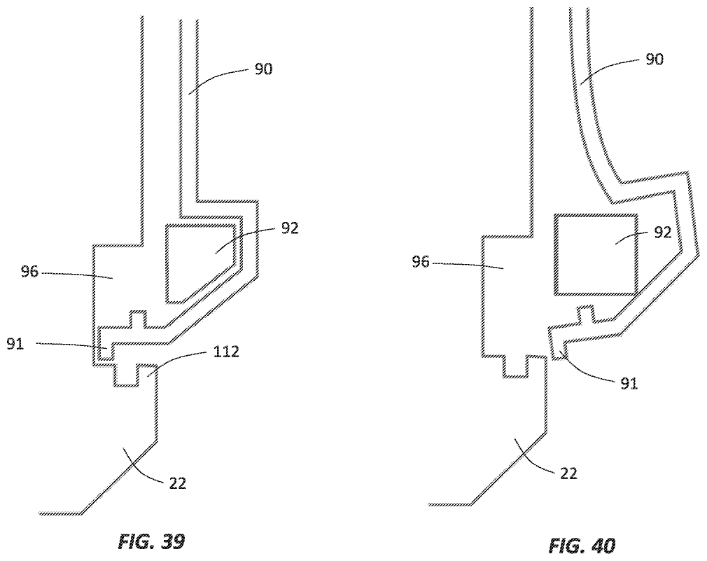

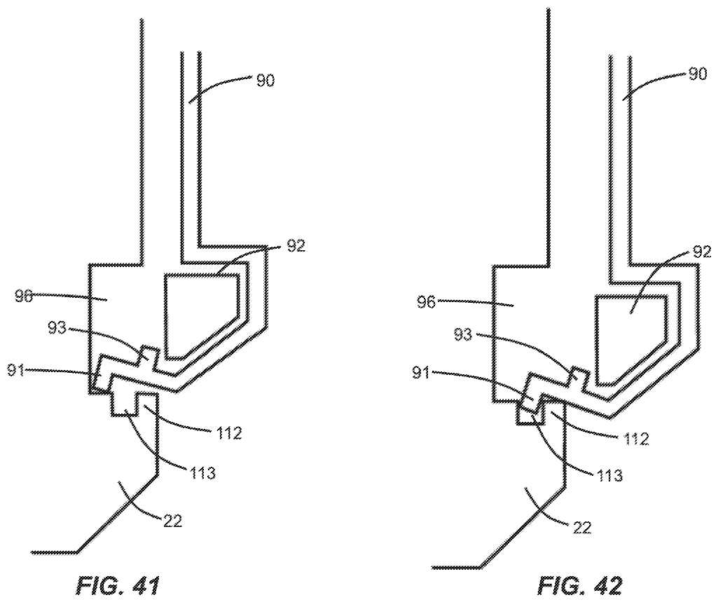

With additional reference to FIGS. 39-42, cross-sectional views of an interaction between the resilient cantilevered latch 90, slide bar 92 and dome closure 22 are depicted an embodiment of the disclosure. FIG. 39 depicts the catch 91 of the resilient cantilevered latch 90 positioned within the notch 96 of the dome closure 22, without contact between the resilient cantilevered latch 90 and the dome closure 22. FIG. 41 depicts the dome closure 22 as having being shifted upwardly relative to the resilient cantilevered latch 90, such that the dome closure 22 physically contacts the catch 91 of the resilient cantilevered latch 90, thereby temporarily flexing or deforming a portion of the resilient cantilevered latch 90.

FIG. 42 depicts the dome closure 22 as having been further shifted upwardly relative to the resilient cantilevered latch 90, which has the effect of further deforming the resilient cantilevered latch 90, thereby causing the catch 91 to be positioned within a notch 113 defined by the dome closure 22 (e.g., defined by the one or more projections 112). In this position, projection 86 positioned on a surface of the latch portion 132 opposite to the catch 91, can be configured to make contact with a portion of the slide bar 92. Accordingly, in this position, the resilient cantilevered latch 90 serves to couple the dome closure 22 to the slider bar 92, which is in turn coupled to the base piece 46, which has the effect of inhibiting removal of the dome closure 22 from the base piece 46 unless or until a material failure of the latch portion 132 occurs. FIG. 40 depicts the catch 91 of the resilient cantilevered latch 90 deflected outwardly away from the notch 96 of the dome closure 22 (e.g., by sliding the slide bar 92 as described), thereby enabling the dome closure 22 to be lifted free from the base piece 46.

In some embodiments, the slide mount section 64 of the base piece 46 can be reinforced by a reinforcing structure such as a metal insert 100. In certain examples, the metal insert 100 has a channel-shaped cross-section and is adapted to be secured within the rear of the slide mount section 64 by a snap-fit connection. The metal insert 100 can be inserted into the back of the base piece 46 at an angle and then snapped into place.

In certain examples, the mounting bracket 20 can include structure for mounting the mounting bracket 20 at various mounting locations in the field. For example, side slots 102 are provided for allowing the mounting bracket 20 to be secured to a pole by straps 103 as shown at FIG. 7. The mounting bracket 20 also includes a plurality of fastener openings 104 and extend in a front to rear direction through the mounting bracket 20. The fastener openings 104 can be defined by tabs or through a main body of the mounting bracket 20. The fastener openings 104 are adapted to receive fasters such as screws or bolts used to secure the mounting bracket to a pole, to a wall, to strand mount brackets 106 (see e.g., FIG. 8), to a cable storage device such as a cable spooling device 108 (see e.g., FIG. 9), or to a work bench (see e.g., FIGS. 17A-B). In certain examples, the base piece 46 of the mounting bracket 20 includes at least four of the fastener openings 104 and the adjustable piece 50 includes at least two of the fastener openings 104.

The dome closure 22 is installed on the mounting bracket 20 by initially positioning the dome closure 22 above the holder 48 with the central axis 28 of the dome closure 22 parallel to the longitudinal axis 58 of the base piece 46. The dome closure 22 is then moved downwardly relative to the mounting bracket while maintaining a parallel relationship with respect to axes 28, 58 until the lower end of the dome closure 22 seats within the holder 48, the engagement feature 52 of the bracket 20 is received within the engagement feature 54 of the dome closure 22 and the resilient latch 90 snaps within the catch 94 of the dome closure 22.

Referring to FIG. 10, to release the combined dome closure 22 (including both the closure base 24 and the dome 26) from the mounting bracket 20, the slide bar 92 is laterally actuated to move the resilient latch 90 to the non-retaining position, and the dome closure 22 is vertically lifted from the holder 48 while maintaining a parallel relationship between the longitudinal axes 28, 58. In this configuration, the closure base 24 and the dome 26 remain secured together with latches 30.

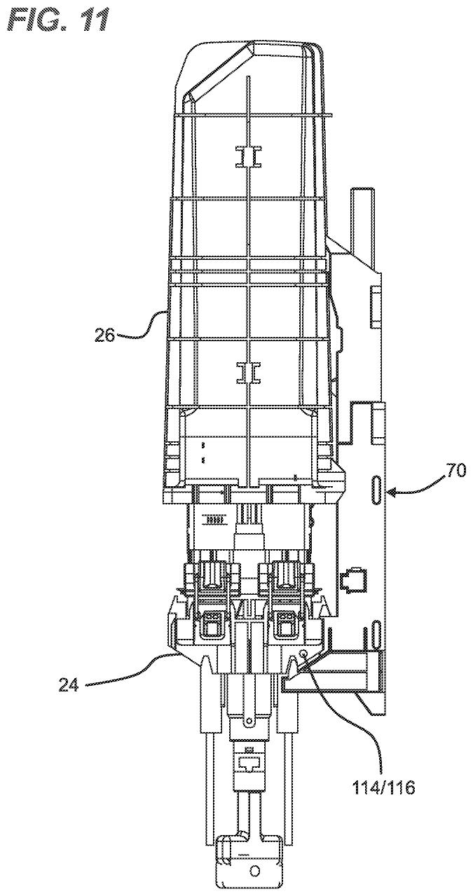

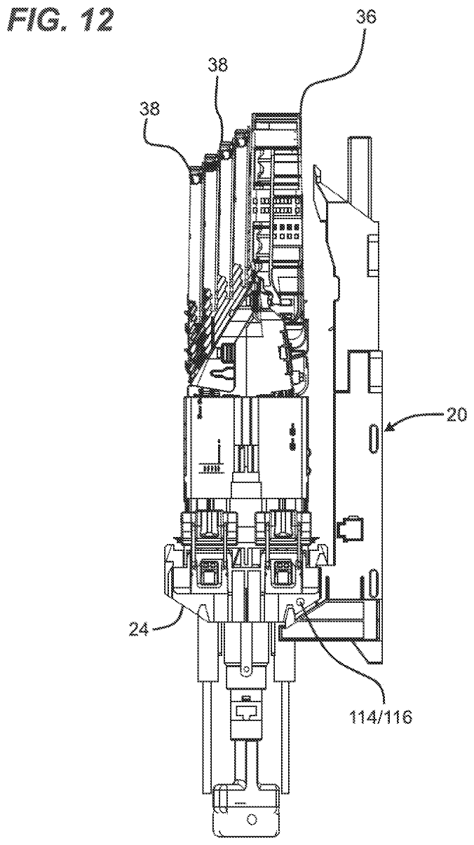

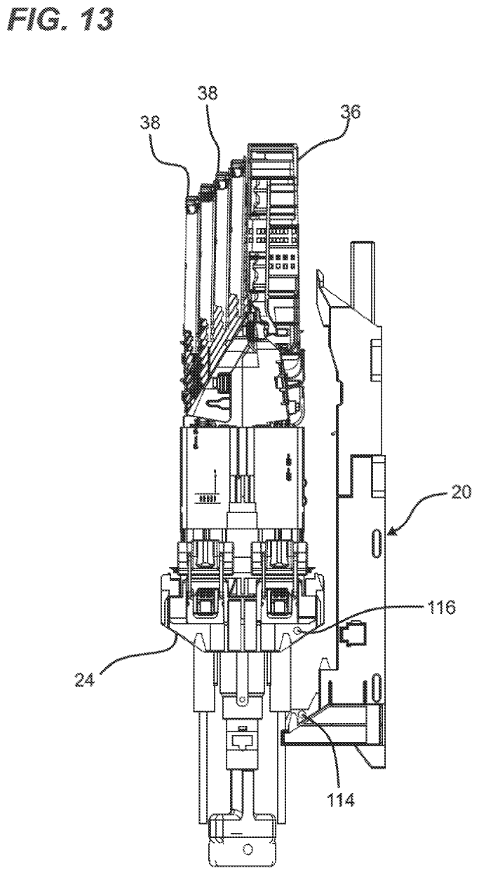

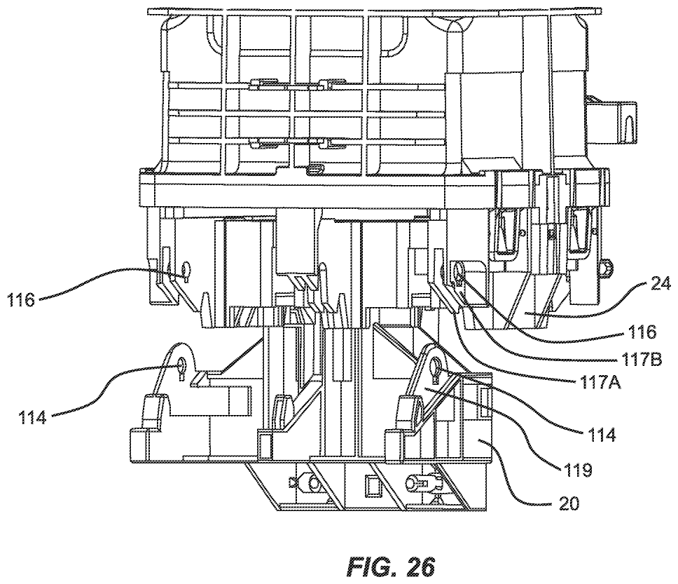

Referring to FIGS. 11-13, while the dome closure 22 is supported by the mounting bracket 20, it is possible to remove the dome 26 from the closure base 24 while the closure base 24 remains supported by the holder 48 of the mounting bracket 20. This can be accomplished by unlatching the latches 30 to unlatch the dome 26 from the closure base 24, and then actuating the slide bar 92 to move the resilient latch 90 to the non-retaining position such that the dome 26 can be lifted from the closure base 24 as shown at FIGS. 11 and 12. With the dome 26 removed from the closure base 24, the closure base 24 remains supported by the holder 48. However, in this configuration, the closure base 24 is no longer latched in place relative to the mounting bracket 20 by the resilient latch 90 and can be removed from the mounting bracket 20 by merely lifting the closure base 24 from the holder 48 as shown at FIG. 13. To inhibit inadvertent separation of the closure base 24 from the mounting bracket 20, one or more apertures 114 can be defined in the mounting bracket 20 and one or more corresponding apertures 116 can be defined in the closure base 24 (as depicted in FIG. 26), such that a locking pin 125 can be positioned through the apertures 114/116 to temporarily secure the mounting bracket 20 to the closure base 24 (as depicted in FIG. 23). For example, as depicted in FIGS. 23 and 26, in some embodiments, apertures 116 can be defined through a pair of fins 117A/B, which when assembled can straddle fin 119 defining aperture 114. In some embodiments, the locking pin 125, which can be in the form of a rod, wire etc. can be retained on the mounting bracket 20. In other embodiments, a tool (e.g., a screwdriver or the like) can be used as the locking pin.

For ease in identification of network components, in some embodiments either of the mounting bracket 20 or dome closure 22 can include an identifier 118 (as depicted in FIG. 28). For example, in some embodiments, the identifier 118 can be in the form of a remotely scannable radio frequency identification (RFID) tag, near field communication (NFC) tag or the like, with a unique identifier configured to aid in proper identification of network components, even when the dome closure 22 is operably coupled to the bracket 20. In some embodiments, the identifier 118 can be operably coupled to the mounting bracket 20 via protuberances 127, 128A-B. For example, the identifier 118 can initially be positioned such that edges of the identifier 118 are held in position by protuberances 128A-B, then snapped into place such that protuberance 127 locks a top edge of the identifier 118 in position. Other structures configured to securely retain identifier 118 relative to the mounting bracket 20 are also contemplated.

### Aspects of the Disclosure

Aspect 1. A mounting bracket for mounting a dome closure to a mounting location in the field, the dome closure including a closure base and a dome, the mounting bracket comprising:
a base piece including a holder for supporting the closure base; and
an adjustable piece including an engagement feature for mating with a corresponding engagement feature of the dome, the adjustable piece being adjustable in position relative to the base piece to accommodate dome closures of different sizes.

Aspect 2. The mounting bracket of any other aspect of the disclosure, wherein the holder includes a plurality of female features for receiving male features of the closure base and also includes a plurality of male features adapted to be received within female features of the closure base.

Aspect 3. The mounting bracket of any other aspect of the disclosure, wherein the female features of the holder include a central channel aligned with a central longitudinal axis of the mounting bracket and notches positioned on opposite side of the central longitudinal axis.

Aspect 4. The mounting bracket of any other aspect of the disclosure, wherein the male features of the holder include a central alignment fin aligned with the longitudinal axis, first hooks positioned on opposite sides of the longitudinal axis and separated by a first lateral spacing, second hooks positioned on opposite sides of the longitudinal axis and separated by a second lateral spacing larger than the first lateral spacing, the first hooks being spaced from the second hooks by an axial spacing measured along the longitudinal axis, the first hooks being located adjacent a top of the holder adjacent an entrance to the central channel and the second hooks being located adjacent a bottom of the holder.

Aspect 5. The mounting bracket of any other aspect of the disclosure, wherein the engagement feature of the adjustable piece includes at least one hook.

Aspect 6. The mounting bracket of any other aspect of the disclosure, wherein the engagement feature of the adjustable piece includes a pair of hooks.

Aspect 7. The mounting bracket of any other aspect of the disclosure, wherein the base piece includes a length that extends along a longitudinal axis of the base piece between a first end and a second end, wherein the holder is located at the second end, wherein the adjustment piece includes a slider, wherein the base piece includes a slider mounting section adjacent the first end of the base piece including a linear guide on which the slider mounts, and wherein the slider is linearly moveable along the linear guide in an orientation parallel to the longitudinal axis to allow the slider to be adjusted in position relative to the base piece.

Aspect 8. The mounting bracket of any other aspect of the disclosure, wherein the slider can be selectively retained at a plurality of locations along the slider mounting section with each location corresponding to a different sized dome closure.

Aspect 9. The mounting bracket of any other aspect of the disclosure, wherein a central axis of the dome closure is moved parallel to the longitudinal axis of the base piece when the dome closure is installed on the mounting bracket and when the dome closure is removed from the mounting bracket.

Aspect 10. The mounting bracket of any other aspect of the disclosure, wherein the dome is removeable from the closure base by moving the dome relative to the closure base along the central axis of the dome closure, and wherein mounting bracket is configured such that the dome can be removed from the closure base while the closure base remains seated at the holder.

Aspect 11. The mounting bracket of any other aspect of the disclosure, further comprising a resilient latch for latching the dome closure in place relative to the mounting bracket when the closure base seats in the holder, wherein the resilient latch is biased toward a retaining position, wherein the resilient latch is moveable to a non-retaining position, wherein when the dome closure is installed on the mounting bracket the resilient latch engages a catch on the dome of the dome closure to prevent the dome closure from lifting axially from the holder, and wherein by moving the latch to the non-retaining position the dome closure can be disengaged from the mounting bracket by lifting the dome closure in a direction along the longitudinal axis of the base piece.

Aspect 12. The mounting bracket of any other aspect of the disclosure, further comprising a slide bar slidably mounted to the base piece for camming the resilient latch to from the retaining position to the non-retaining position when it is desired to disengage the dome closure from the bracket, the slide bar being slidably moveable in a direction transverse with respect to the longitudinal axis of the base piece.

Aspect 13. The mounting bracket of any other aspect of the disclosure, wherein the base piece is a molded plastic part, and wherein the mounting bracket includes a metal reinforcing channel that mounts to the base piece to reinforce the slider mounting section.

Aspect 14. The mounting bracket of any other aspect of the disclosure, wherein the slider includes at least two fastener openings and the base piece includes at least four fastener openings, the fastener openings being configured for receiving fasteners for securing the mounting bracket at a mounting location.

Having described the preferred aspects and implementations of the present disclosure, modifications and equivalents of the disclosed concepts may readily occur to one skilled in the art. However, it is intended that such modifications and equivalents be included within the scope of the claims which are appended hereto.

Various embodiments of the present disclosure will be described in detail with reference to the drawings, where like reference numerals represent like parts and assemblies throughout the several views. Reference to various embodiments does not limit the scope of the invention, which is limited only by the scope of the claims attached hereto. Additionally, any example set forth in the specification is not intended to be limiting and merely sets forth some of the many possible embodiments for the claimed invention.

1. A mounting bracket for mounting a dome closure to a mounting location in the field, the dome closure including a closure base and a dome, the mounting bracket comprising:
a base piece including a holder for supporting the closure base; and
an adjustable piece including an engagement feature for mating with a corresponding engagement feature of the dome, the adjustable piece being adjustable in position relative to the base piece to accommodate dome closures of different sizes.

2. The mounting bracket of claim 1, wherein the holder includes a plurality of female features for receiving male features of the closure base and also includes a plurality of male features adapted to be received within female features of the closure base.

3. The mounting bracket of claim 1, wherein the female features of the holder include a central channel aligned with a central longitudinal axis of the mounting bracket and notches positioned on opposite side of the central longitudinal axis.

4. The mounting bracket of claim 1, wherein the male features of the holder include a central alignment fin aligned with the longitudinal axis, first hooks positioned on opposite sides of the longitudinal axis and separated by a first lateral spacing, second hooks positioned on opposite sides of the longitudinal axis and separated by a second lateral spacing larger than the first lateral spacing, the first hooks being spaced from the second hooks by an axial spacing measured along the longitudinal axis, the first hooks being located adjacent a top of the holder adjacent an entrance to the central channel and the second hooks being located adjacent a bottom of the holder.

5. The mounting bracket of claim 1, wherein the engagement feature of the adjustable piece includes at least one hook.

6. The mounting bracket of claim 1, wherein the engagement feature of the adjustable piece includes a pair of hooks.

7. The mounting bracket of claim 1, wherein the base piece includes a length that extends along a longitudinal axis of the base piece between a first end and a second end, wherein the holder is located at the second end, wherein the adjustment piece includes a slider, wherein the base piece includes a slider mounting section adjacent the first end of the base piece including a linear guide on which the slider mounts, and wherein the slider is linearly moveable along the linear guide in an orientation parallel to the longitudinal axis to allow the slider to be adjusted in position relative to the base piece.

8. The mounting bracket of claim 1, wherein the slider can be selectively retained at a plurality of locations along the slider mounting section with each location corresponding to a different sized dome closure.

9. The mounting bracket of claim 1, wherein a central axis of the dome closure is moved parallel to the longitudinal axis of the base piece when the dome closure is installed on the mounting bracket and when the dome closure is removed from the mounting bracket.

10. The mounting bracket of claim 1, wherein the dome is removeable from the closure base by moving the dome relative to the closure base along the central axis of the dome closure, and wherein mounting bracket is configured such that the dome can be removed from the closure base while the closure base remains seated at the holder.

11. The mounting bracket of claim 1, further comprising a resilient latch for latching the dome closure in place relative to the mounting bracket when the closure base seats in the holder, wherein the resilient latch is biased toward a retaining position, wherein the resilient latch is moveable to a non-retaining position, wherein when the dome closure is installed on the mounting bracket the resilient latch engages a catch on the dome of the dome closure to prevent the dome closure from lifting axially from the holder, and wherein by moving the latch to the non-retaining position the dome closure can be disengaged from the mounting bracket by lifting the dome closure in a direction along the longitudinal axis of the base piece.

12. The mounting bracket of claim 1, further comprising a slide bar slidably mounted to the base piece for camming the resilient latch to from the retaining position to the non-retaining position when it is desired to disengage the dome closure from the bracket, the slide bar being slidably moveable in a direction transverse with respect to the longitudinal axis of the base piece.

13. The mounting bracket of claim 1, wherein the base piece is a molded plastic part, and wherein the mounting bracket includes a metal reinforcing channel that mounts to the base piece to reinforce the slider mounting section.

14. The mounting bracket of claim 1, wherein the slider includes at least two fastener openings and the base piece includes at least four fastener openings, the fastener openings being configured for receiving fasteners for securing the mounting bracket at a mounting location.

15. A mounting bracket configured to enable mounting of one of a plurality of different sized dome closures to a mounting location, the mounting bracket comprising:
a base piece defining a holder for supporting a closure base of a dome closure, the base piece defining one or more male features adapted to be received within one or more female features defined by the closure base of the dome closure; and
an adjustable piece selectively couplable to the base piece at one of a plurality of different locations corresponding to each of a plurality of different size dome closures, the adjustable piece including an engagement feature configured to be received within a mating engagement feature defined by a dome of the dome closure.

16. The mounting bracket of claim 15, wherein the mounting location is at least one of a wall, pole, tower, strand, cable spooling device, or workbench.

17. The mounting bracket of claim 15, wherein the adjustable piece is selectively couplable to the base piece at a first location for receipt of a dome closure of a first size, at a second location for receipt of a dome closure of a second size, and at a third location for receipt of a dome closure of a third size.

18. The mounting bracket of claim 15, further comprising a remotely scannable identifier configured to aid in proper identification of components within a sealed dome closure.

19. The mounting bracket of claim 15, wherein the base piece defines a central channel configured to receive one of at least two generally T-shaped retaining members of the closure base of the dome closure.

20. The mounting bracket of claim 15, wherein the base piece includes a plurality of female features for receiving male features of the closure base and a plurality of male features adapted to be received within female features of the closure base.

21. The mounting bracket of claim 20, wherein the female features of the holder include a central channel aligned with a central longitudinal axis of the mounting bracket and notches positioned on opposite side of the central longitudinal axis.

22. The mounting bracket of claim 15, further comprising a slide bar configured to manipulate a resilient latch between a retaining position configured to lock a dome of the dome closure in place relative to the mounting bracket, and a non-retaining position configured to enable selective removal of the dome from the mounting bracket.

23. The mounting bracket of claim 22, wherein the resilient latch is configured to be received within a notch defined by the dome of the dome closure.

24. The mounting bracket of claim 15, wherein the resilient latch defines an aperture configured to receive one or more projections defined on an inner surface of the notch defined by the dome of the dome closure when a lifting force is applied to the dome closure.

25. The mounting bracket of claim 24, wherein the base piece and the closure base each define an aperture, such that when the closure base is received on the base piece the apertures of the base piece and the closure are aligned to enable a locking pin to be positioned therethrough, thereby securing the closure base to the base piece.

26. The mounting bracket of claim 15, wherein a central axis of the dome closure is moved parallel to the longitudinal axis of the base piece when the dome closure is installed on the mounting bracket and when the dome closure is removed from the mounting bracket.

27. The mounting bracket of claim 26, wherein the dome is removeable from the closure base by moving the dome relative to the closure base along a central axis of the dome closure, and wherein the mounting bracket is configured such that the dome can be removed from the closure base while the closure base remains seated on the holder.

28. The mounting bracket of claim 15, wherein the base piece is a molded plastic part, and wherein the mounting bracket includes a metal reinforcing channel that mounts to the base piece to reinforce a slider mounting section.

29. The mounting bracket of claim 28, wherein the slider mounting section includes at least two fastener openings and the base piece includes at least four fastener openings, the fastener openings being configured for receiving fasteners for securing the mounting bracket at a mounting location.

30-42. (canceled)
